(19) United States
(12) Patent Application Publication
(10) Pub. No.: US 2014/0107899 A1
(43) Pub. Date: Apr. 17, 2014

(54) REFERENCE POSITION SETTING METHOD FOR AUTOMATED MANUAL TRANSMISSION

(71) Applicants: HYUNDAI MOTOR COMPANY, Seoul (KR); KIA MOTORS CORPORATION, Seoul (KR)

(72) Inventors: Young Min YOON, Seoul (KR); Hyun Cheol HWANG, Seoul (KR)

(73) Assignees: Kia Motors Corporation, Seoul (KR); Hyundai Motor Company, Seoul (KR)

(21) Appl. No.: 13/710,409

(22) Filed: Dec. 10, 2012

(30) Foreign Application Priority Data
Oct. 11, 2012 (KR) 10-2012-0112891

(51) Int. Cl. F16H 59/02

(52) U.S. Cl. CPC F16H 59/02
USPC 701/51

(57) ABSTRACT

A reference position setting method for an automated manual transmission on which actuators driven by motors are mounted without a position sensor for detecting a position of each finger is capable of initializing a reference position of the finger as rapidly and accurately as possible.

### CROSS-REFERENCE TO RELATED APPLICATION

The present application claims priority of Korean Patent Application Number 10-2012-0112891 filed Oct. 11, 2012, the entire contents of which application is incorporated herein for all purposes by this reference.

### BACKGROUND OF INVENTION

1. Field of Invention

The present invention relates, in general, to a reference position setting method for an automated manual transmission and, more particularly, to a reference position setting method for controlling actuators in an automated manual transmission, in which shifting is performed by a selecting operation for selecting a shift rail to which a target shift range to be shifted is assigned and a shifting operation for moving the selected shift rail to shift into the target shift range, and the selecting operation and the shifting operation are realized using the actuators.

2. Description of Related Art

FIG. 1 illustrates a shift mechanism of a conventional automated manual transmission, particularly a double clutch transmission, to which the present invention can be applied.

In FIG. 1, two fingers F for a selecting operation caused by upward or downward movement and a shifting operation caused by pivoting are provided. Odd and even range selecting actuators 9 and 13 moving the two fingers in upward and downward directions, respectively, and odd and even range shifting actuators 11 and 15 pivoting the two fingers in leftward and rightward directions, respectively, are provided. As shown in FIG. 2, the two fingers F are configured so that, in respective shift gate patterns, they move up or down to perform the selecting operation, and move left or right to perform the shifting operation, thereby performing desired shifting.

Here, the odd and even range selecting actuators 9 and 13 are implemented as solenoid actuators, and the odd and even range shifting actuators 11 and 15 are configured as motors. In view of a characteristic of each motor, a separate position sensor is required to recognize a position of the finger F based on the operation of the motor. However, the position sensor increases the cost of a product, and is unfavorable in terms of configuration and weight of a package. Thus, a method of allowing a controller to accurately recognize the position of the finger F without the position sensor is required.

The following method has been used to recognize the position of the finger. In detail, the finger is forced to be located at a specific reference position when a vehicle is started. If the reference position is detected, the subsequent rotation of a motor is calculated on the basis of the reference position, and a position of the finger is followed up and recognized.

For reference, the reference positions of the two fingers F are shown in FIG. 2. Since the fingers F are not guaranteed to be located at the shown reference positions when a vehicle is started, an initialization operation of moving the fingers F to the reference positions should be performed.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art, and the present invention is intended to propose a reference position setting method for an automated manual transmission on which actuators driven by motors are mounted without a position sensor for detecting a position of each finger, capable of initializing a reference position of the finger as rapidly and accurately as possible.

Various aspects of the present invention provide for a reference position setting method for an automated manual transmission, which includes: reciprocating a finger in a selecting direction to check whether or not the finger is normal; and operating the finger in a shifting direction to learn a reference position of the finger if, as a result of performing the step of checking whether or not the finger is normal, it is determined that the finger is not normal.

According to the present invention, in the automated manual transmission on which actuators driven by motors are mounted without a position sensor for detecting a position of each finger, the reference position setting method is capable of initializing a reference position of the finger as rapidly and accurately as possible.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a shift mechanism of an automated manual transmission in the related art;

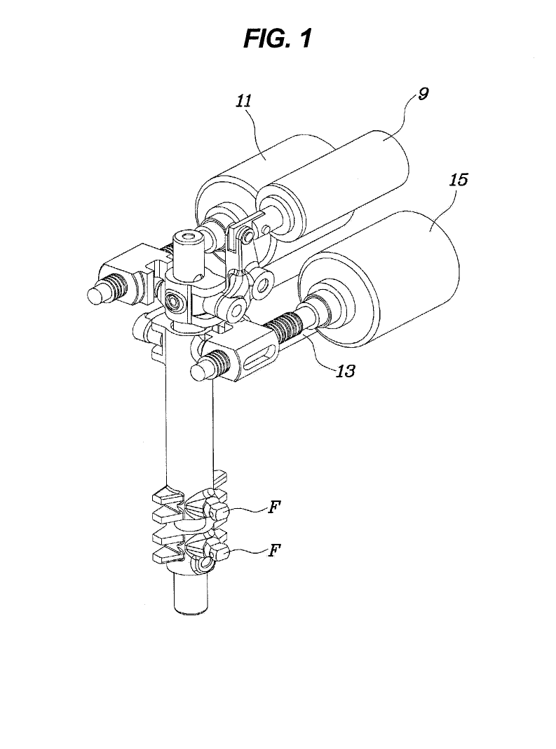

FIG. 2 shows shift gate patterns and reference positions of fingers based on the shift mechanism of FIG. 1;

FIG. 3 is a flowchart showing an exemplary reference position setting method for an automated manual transmission in accordance with the present invention; and

FIG. 4 is an explanatory view showing an exemplary method of initializing a reference position of each finger in accordance with the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

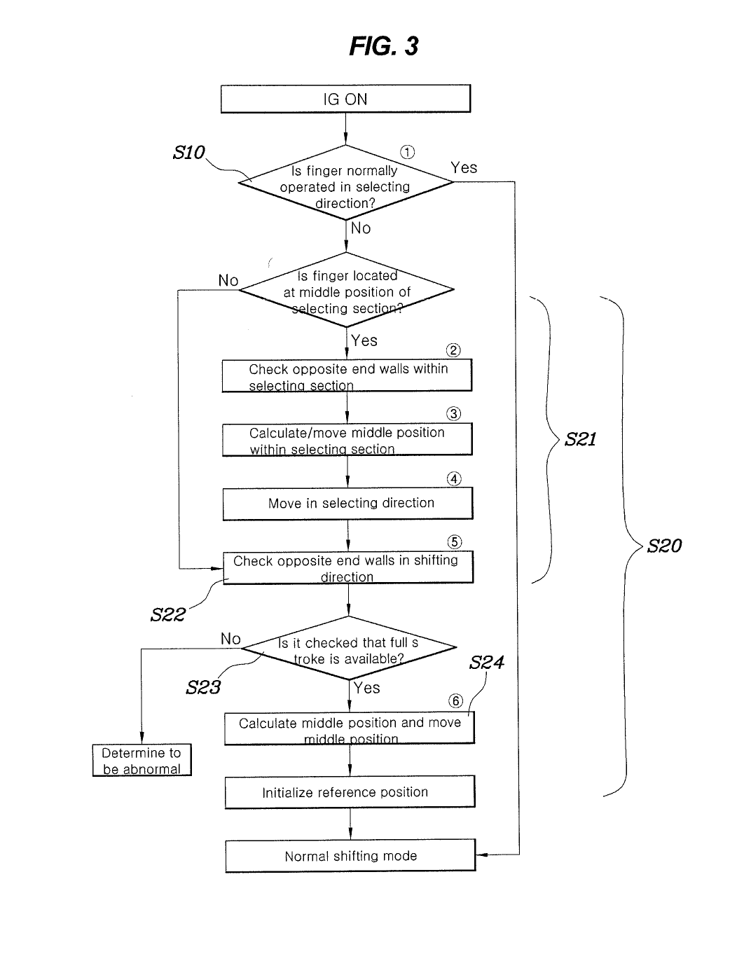

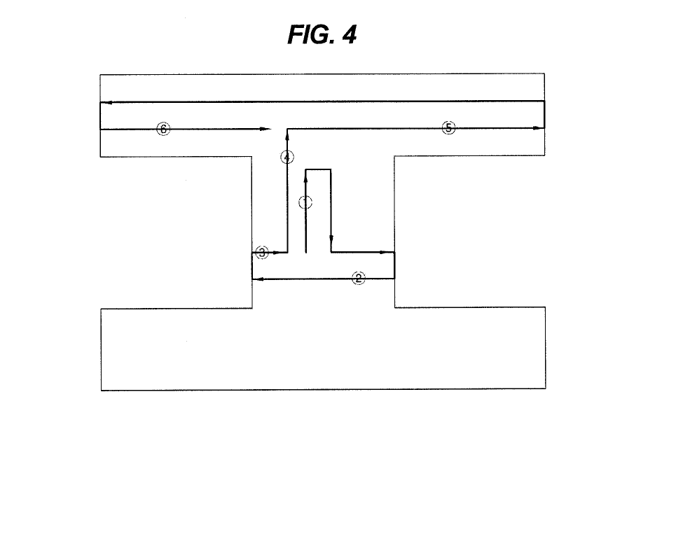

Referring to FIGS. 3 and 4, a reference position setting method for an automated manual transmission in accordance with various embodiments of the present invention includes step S10 of reciprocating a finger in a selecting direction to check whether or not the finger is normal, and step S20 of operating the finger in a shifting direction to learn a reference position of the finger if it is determined from a result of the checking in step S10 that the finger is not normal.

In detail, the present invention is configured so that, if there occurs a situation such as ignition-on in which the reference position of the finger is required to be initialized, it is checked in step S10 whether a normal selecting operation is performed by selecting-direction reciprocation of the finger obtained by operation of a solenoid actuator in the first place, and so that, if the normal selecting operation is performed, a current shifting mode is converted into a normal shifting mode in which normal shifting can be performed from this time by adopting a current position of the finger as the reference position, and if the normal selecting operation is not performed, a new reference position of the finger is learned and initialized in step S20.

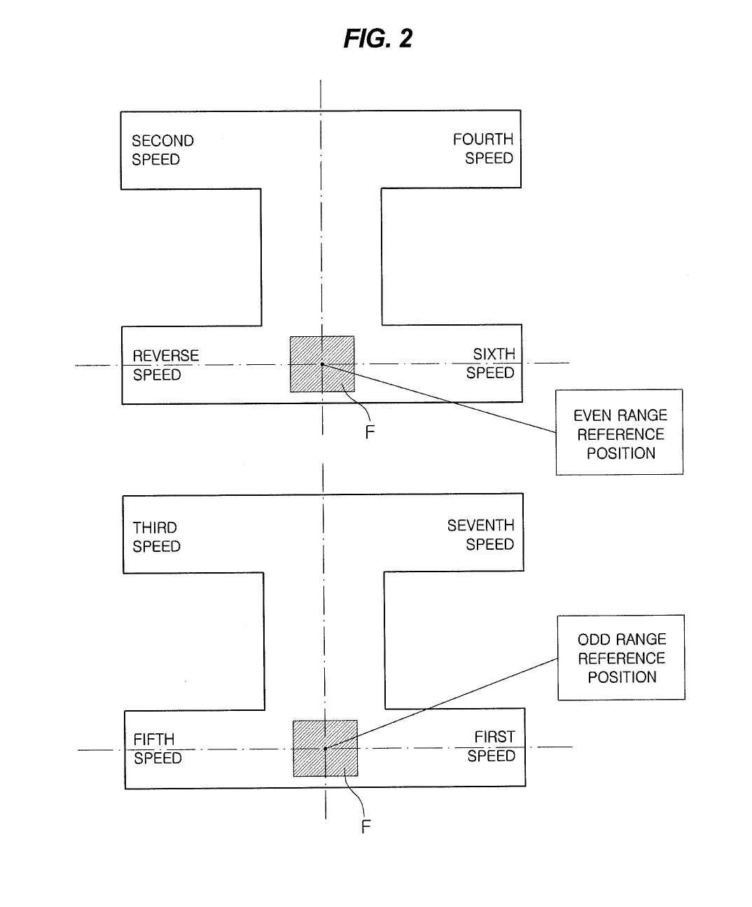

For reference, FIG. 4 shows only any one of the shift gate patterns in the transmission in which the fingers for the odd and even ranges as shown in FIG. 2 are separately provided. The same method can be applied to the other shift gate pattern. Furthermore, the present invention may be applied to slightly different shift gate patterns Further, numerals of FIG. 3 correspond to those shown in FIG. 4, and denote movement of the finger in the respective steps.

Step S20 includes sub-step S22 of reciprocating the finger in the shifting direction to check opposite ends of the shifting direction, and sub-step S24 of calculating a middle position between the opposite ends of the shifting direction, which are checked in sub-step S22, to move the finger to the middle position.

This step S20 may be applied to a case in which the finger is located within a shifting section when step S10 is terminated. When sub-steps S22 and S24 are performed, the finger can be located at the reference position. Thereby, the initialization of the reference position of the finger can be completed.

However, in various embodiments, several sub-steps are additionally provided in addition to these sub-steps. Sub-step S23 of determining whether a full stroke between the opposite ends of the shifting direction, which are checked in sub-step S22, is available, and allowing progress of sub-step S24 only when the full stroke is available is additionally provided between sub-steps S22 and S24. Thereby, the reference position of the finger can be more reliably initialized.

Of course, as a result of the determination in sub-step S23, if it is determined that the full stroke of the finger in the shifting direction is not available, this is determined to be abnormal, and follow-up measures are allowed to be taken.

Further, in step S20, when the finger is fixed within a selecting section, sub-step S21 of coping with this fixture is additionally provided prior to sub-step S22.

In various embodiments, sub-step S21 is performed by, when it is determined that the finger is located at a middle position of the selecting section, reciprocating the finger in the shifting direction to check opposite end walls of the shifting direction within the selecting section, calculating the middle position of the selecting section between the opposite end walls, moving the finger to the middle position of the selecting section between the opposite end walls, and moving the finger to one side of the selecting direction.

In detail, as a result of the checking in step S10, if the finger is not normal, it is first determined in sub-step S21 whether the finger is located at the middle position of the selecting section, and the finger is moved from the selecting section to the shifting section. Then, sub-step S22 is allowed to be performed.

Of course, if it is determined in sub-step S21 that the finger is located within the shifting section rather than the middle position of the selecting section, sub-step S24 is allowed to be immediately performed to rapidly complete the initialization of the reference position of the finger.

Meanwhile, the aforementioned reference position setting method for an automated manual transmission is allowed to be automatically performed by an electronic control unit.

For convenience in explanation and accurate definition in the appended claims, the terms left or right, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A reference position setting method for an automated manual transmission, comprising:
reciprocating a finger in a selecting direction to determine whether or not the finger is normal; and
operating the finger in a shifting direction to learn a reference position of the finger if; as a result of performing the step of checking whether or not the finger is normal, it is determined that the finger is not normal.

2. The reference position setting method according to claim 1, wherein the step of learning the reference position of the finger includes:
reciprocating the finger in the shifting direction to check opposite ends of the shifting direction; and
calculating a middle position between the checked opposite ends of the shifting direction to move the finger to the middle position.

3. The reference position setting method according to claim 2, wherein the step of learning the reference position of the finger further includes determining whether a full stroke between the checked opposite ends of the shifting direction is available, and allowing progress of the step of moving the finger to the middle position only when the full stroke is available between the step of checking the opposite ends of the shifting direction and the step of moving the finger to the middle position.

4. The reference position setting method according to claim 2, wherein the step of learning the reference position of the finger further includes, when the finger is fixed within a selecting section, coping with the fixture of the finger prior to the step of checking the opposite ends of the shifting direction.

5. The reference position setting method according to claim 4, wherein the step of coping with the fixture of the finger is performed by, when it is determined that the finger is located at a middle position of the selecting section, reciprocating the finger in the shifting direction to check opposite end walls of the shifting direction within the selecting section, calculating the middle position of the selecting section between the opposite end walls, moving the finger to the middle position of the selecting section between the opposite end walls, and moving the finger to one side of the selecting direction.

6. An electronic control unit provided to perform the reference position setting method according to claim 1.

7. An electronic control unit provided to perform the reference position setting method according to claim 2.

8. An electronic control unit provided to perform the reference position setting method according to claim 3.

9. An electronic control unit provided to perform the reference position setting method according to claim 4.

10. An electronic control unit provided to perform the reference position setting method according to claim 5.
